(19) United States
(12) Patent Application Publication
(10) Pub. No.: US 2005/0233090 A1
(43) Pub. Date: Oct. 20, 2005

(54) Technique and process for modification of coatings produced during impact consolidation of solid-state powders

(76) Inventors: Ralph M. Tapphorn, Goleta, CA (US); Howard Gabel, Santa Barbara, CA (US)

Correspondence Address: Ralph Tapphorn;Innovative Technology, Inc., (dba) Inovati, P.O. Box 60007, Santa Barbara, CA, 93160, US

(21) Appl. No.: 11/106,630

(22) Filed: Apr. 15, 2005

Related U.S. Application Data
(60) Provisional application No. 60/562,518, filed on Apr. 16, 2004.

(51) Int. Cl. B05D 3/00; C04B 41/00

(52) U.S. Cl. 427/532; 427/372.2; 427/592

(57) ABSTRACT

The invention relates to various methods for modifying material properties during solid-state impact consolidation of coatings and free-form fabrication of structures. The invention discloses a new method for modifying the physical and chemical properties of the substrate, coating, and free-form structure during and simultaneous to impact consolidation and accretion of powders using a solid-state deposition process. The physical and chemical properties of the substrate, coating, and free-form structure in close proximity to the impact consolidation process can be modified by heating or by exposing to gaseous and liquid environments. Heating of the substrate, coating, or free-form structure up to annealing temperatures for most materials significantly reduces the plastic deformation flow stresses and permits the impact consolidation process to enhance deposition efficiency, improve densification, anneal dislocations, and improve adhesion and cohesion through in-situ diffusion bonding.

### CROSS-REFERENCE TO RELATED APPLICATIONS

This application claims the benefit of a previously-filed provisional patent application Ser. No. 60/562,518, filed on Apr. 16, 2004.

### BACKGROUND

1. Technical Field

The present invention relates to various methods for modifying material properties during solid-state impact consolidation of coatings and free-form fabrication of structures. The invention discloses a new method for modifying the physical and chemical properties of the substrate, coating, and free-form structure during and simultaneous to impact consolidation and accretion of powders using the solid-state deposition process (hereafter referred to as “impact consolidation process”) such as the processes disclosed in U.S. Pat. No. 6,074,135 issued to Tapphorn and Gabel, U.S. Pat. No. 5,795,626 issued to Gabel and Tapphorn, U.S. Pat. No. B1 5,302,414 issued to Alkhimov, et al., U.S. Patent Application 20020168466, and PCT Patent Application WO 02/085532 A1. The physical and chemical properties of the substrate, coating, and free-form structure in close proximity to the impact consolidation process can be modified by heating or by exposing to gaseous and liquid environments. In addition, the invention discloses methods of performing spray deposition within inert environments including gaseous and liquid shields in close proximity to the impact consolidation process. Close proximity for the method of this invention is defined to be within a distance from the impact consolidation process such that the physical and chemical properties of the substrate, coating, and free-form structure can be modified by heating or chemical treatment within times or distances consistent with the nozzle translation speeds for the impact consolidation process. For example, thermal diffusivities of the substrate, coating, or free-form structure can be used to determine the appropriate distance for various nozzle translation speeds during heating. Close proximity also includes being coincident with the nozzle jet associated with the impact consolidation process.

2. Background Art

U.S. Patent Application 20020168466 filed by Tapphorn and Gabel discloses various methods of heating a substrate, coating and free-form structure with concentric plasma impinging on the surface and circumferentially surrounding a particle impact jet. Improvements to U.S. Patent Application 20020168466 filed by Tapphorn and Gabel are disclosed herein by using various ancillary equipment to heat the substrate, coating, and free-form structure in close proximity to the impact consolidation process.

### SUMMARY

Heating of a substrate, coating, or free-form structure up to annealing temperatures for most materials significantly reduces the plastic deformation flow stresses and permits the impact consolidation process to enhance deposition efficiency, improve densification, anneal dislocations, and improve adhesion and cohesion through in-situ diffusion bonding. The advantage of the invention method over high-temperature thermal spray technology is that coatings and free-form structures can be deposited at temperatures significantly below the melting points of the materials, which reduces oxide contamination and thermal distortion. Using the impact consolidation process in combination with heating the substrate, coating, or free-form structure up to annealing temperatures for the materials of construction, coatings can be deposited with improved properties over that obtained with conventional thermal spray methods. Frequently, for the impact consolidation process the powder entrained in an inert gaseous jet is heated to temperatures in the range of 100 to 1000° F. to render the powder more ductile. Likewise, since the substrate and incremental coating buildup participate in the impact collision process, significant improvements to the properties of the coating or free-form structure can be realized through independent heating up to temperatures consistent with annealing the substrate, coating, or free-form structure.

Introduction of gases or liquids in close proximity to the impact consolidation process additionally provides the means for modifying the physical and chemical properties of a substrate, coating or free-form structure during the spray process by precluding oxidation and reaction with the surrounding environment. For example a purge of inert gases (including by not limited to helium, nitrogen, and argon) introduced with a plurality of nozzles surrounding the impact consolidation nozzle can be used to shield the process from further oxidation during deposition of reactive powders used for coatings or free-form fabrication. Other examples include introducing chemically reactive admixture gases including but not limited to diatomic and mono-atomic species of hydrogen, chlorine, fluorine, and oxygen with a plurality of nozzles surrounding the impact consolidation nozzle to react with the substrate, coating, or free-form materials during deposition of powders used for coatings or free-form fabrication.

Stripping of oxides and other contaminates from the surface of the powder particles, substrate, coating, or free-form structure is also accomplished by a combination of chemical and physical treatments in close proximity to the impact consolidation process. Chemically reactive admixture gases including but not limited to diatomic and mono-atomic species of hydrogen, chlorine, fluorine, and oxygen introduced with a plurality of nozzles surrounding the impact consolidation process can be heated to enhance surface reactivity to potentially strip oxides and contaminates from the surface of the powder particles, substrate, coating, or free-form structure. In addition, ionized and plasma species of gases including but not limited to diatomic and mono-atomic species of hydrogen, chlorine, fluorine, and oxygen introduced with a plurality of nozzles surrounding the impact consolidation process can used to enhance surface reactivity to potentially strip oxides and contaminates from the surface of the powder particles, substrate, coating, or free-form structure.

Addition of hard phase powder particles to the inert gas or inert gas with chemically reactive admixtures can be use to physically strip oxides and other contaminates from the surface of the substrate, coating, or free-form structure by sandblasting or grit blasting the surfaces simultaneous to and in close proximity to the impact consolidation process.

The invention also discloses a means of modify the physical and chemical properties of impact consolidated coatings and free-form structures by shielding the impact consolidation process, substrate, coating, or free-form structure from a reactive environment using various liquids surrounding the nozzle jet used for the impact consolidation process of depositing powders. The liquids can be selected from a group including but not limited to water, alcohol, ethylene glycol, acetone, silicone liquids, and hydrocarbon liquids. By using inert accelerant gases with the impact consolidation process, the nozzle jet displaces the surrounding liquid shield so a not to impede the impact consolidation process, yet provides the means for shielding reactive powders, coatings, and free-form structures from a chemically reactive atmosphere. Thus, this technique enables the deposition of pyrophoric powders and materials without oxidation or combustion.

### DESCRIPTION OF THE DRAWINGS

The specific features, aspects, and advantages of the present invention will become better understood with regard to the following description, appended claims, and accompanying drawings where:

FIG. 1. Cross-section view of a nozzle depositing a coating or free-form structure using the impact consolidation process wherein the substrate is heated by a substrate heating element.

FIG. 2. Cross-section view of a nozzle depositing a coating or free-form structure on a substrate that is physically or chemically treated in close proximity to the deposition nozzle by a plurality of nozzles impinging gaseous jets on the substrate, deposited coating, or free-form structure simultaneous to the impact consolidation process.

FIG. 3. Cross-section view of a nozzle depositing a coating or free-form structure on a substrate that is heated or chemically treated in close proximity to the deposition nozzle by a plurality of electrodes (e.g., TIG electrodes) impinging a gaseous plasma jet or arc on the deposited coating or free-form structure simultaneous to impact consolidation process.

FIG. 4. Cross-section view of a nozzle depositing a coating or free-form structure on a substrate that is heated or chemically treated in close proximity to the deposition nozzle by a plurality of fiber-optic cables impinging a LASER beam of electromagnetic radiation on the deposited coating or free-form structure simultaneous to the impact consolidation process.

FIG. 5. Cross-section view of a nozzle depositing a coating or free-form structure on a substrate that is installed in a vessel or container in which an inert or chemically reactive gas is flooded in close proximity to the deposition nozzle to modify the physical or chemical properties of the substrate, coating, or free-form structure simultaneous to the impact consolidation process.

FIG. 6. Cross-section view of a nozzle depositing a coating or free-form structure on a substrate that is installed in a vessel or container in which a liquid material is flooded in close proximity to the deposition nozzle to modify the physical or chemical properties of the substrate, coating, or free-form structure or to shield the substrate, deposited coating, or free-form structure from contaminates in the surrounding environment.

### DETAILED DESCRIPTION OF THE PREFERRED EMBODIMENTS

In the following description of the preferred embodiments of the present invention, reference is made to the accompanying drawings which form a part hereof, and in which is shown by way of illustration specific embodiments in which the invention may be practiced. It is understood that other embodiments may be utilized and structural changes may be made without departing from the scope of the present invention.

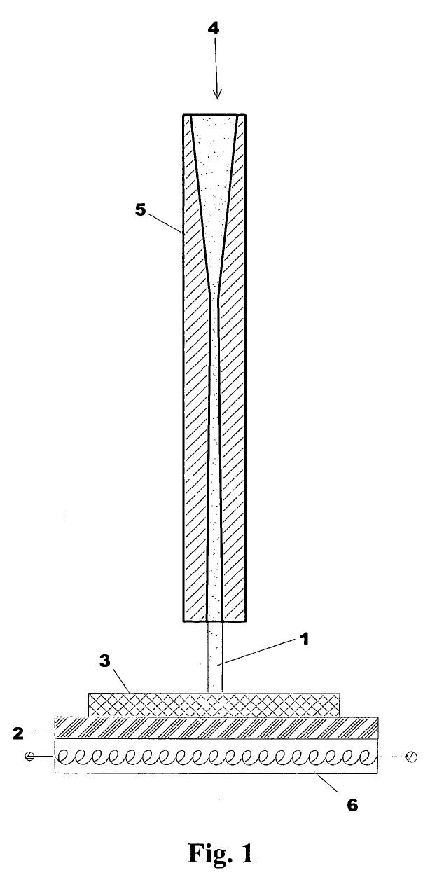

FIG. 1 shows one embodiment of the invention method for modifying the properties of a substrate, coating, or free-form structure during the impact consolidation process of depositing powders as described in U.S. Pat. No. 6,074,135 issued to Tapphorn and Gabel, U.S. Pat. No. 5,795,626 issued to Gabel and Tapphorn, U.S. Pat. No. B1 5,302,414 issued to Alkhimov, et al., U.S. Patent Application 20020168466, and PCT Patent Application WO 02/085532 A1. Referring now to FIG. 1, a nozzle jet 1 directed toward substrate 2 is shown depositing a coating 3 onto substrate 2 using the impact consolidation process, where the powder entrained in the process gas 4 is injected into the nozzle 5 by means described in U.S. Pat. No. 6,715,640 issued to Tapphorn and Gabel, U.S. Pat. No. 6,074,135 issued to Tapphorn and Gabel, U.S. Pat. No. 5,795,626 issued to Gabel and Tapphorn, U.S. Patent Application 20020168466, PCT Patent Application WO 02/085532 A1 or by other conventional means. A resistive substrate heater 6 powered by an electrical current is used to preheat and heat the substrate 2 so that the coating properties are modified during the impact consolidation process. The resistive substrate heater 6 is in good thermal contact with the substrate 2. Heating of the substrate 2, coating 3, or free-form structure up to annealing temperatures for most materials significantly reduces the plastic deformation flow stresses and permits the impact consolidation process to enhance deposition efficiency, improve densification, anneal dislocations, and improve adhesion and cohesion through in-situ diffusion bonding.

### EXAMPLE 1

The embodiment depicted in FIG. 1 was tested and evaluated using an electrical resistive substrate heater 6 to both preheat and heat the substrate 2 during impact consolidation of powder particles onto the substrate 2. Preheating and heating the substrate 2 to 200-500° F. improved the adhesion and cohesion of powder particles consolidated as nickel and nickel alloy coatings onto steel substrates.

In addition, such coatings have higher densities, increased tensile and shear strength and are more ductile than similar coatings applied with an impact consolidation process in which the substrate temperature was not preheated and heated with the electrical resistive heater 6 described in FIG. 1.

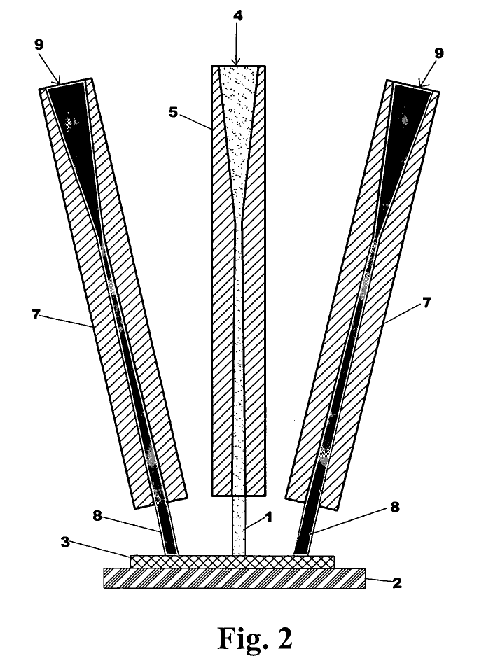

FIG. 2 shows a second embodiment of the invention method for modifying the properties of a substrate, coating, or free-form structure during the impact consolidation process of depositing powders as described in U.S. Pat. No. 6,074,135 issued to Tapphorn and Gabel, U.S. Pat. No. 5,795,626 issued to Gabel and Tapphorn, U.S. Pat. No. B1 5,302,414 issued to Alkhimov, et al., U.S. Patent Application 20020168466, and PCT Patent Application WO 02/085532 A1. Referring now to FIG. 2, a nozzle jet 1 directed toward substrate 2 is shown depositing a coating 3 onto substrate 2 using the impact consolidation process, where the powder entrained in the process gas 4 is injected into the nozzle 5 by means described in U.S. Pat. No. 6,715,640 issued to Tapphorn and Gabel, U.S. Pat. No. 6,074,135 issued to Tapphorn and Gabel, U.S. Pat. No. 5,795,626 issued to Gabel and Tapphorn, U.S. Patent Application 20020168466, PCT Patent Application WO 02/085532 A1 or by other conventional means. A plurality of nozzles 7 impinging gaseous jets 8 onto substrate 2 and subsequently on to the coating 3 or free-form structure in close proximity to the nozzle jet 1 provide the means for heating the substrate 2 and coating 3 by injecting hot gas 9 into a plurality of nozzles 7. The hot gas 9 is typically an inert gas selected from a group including but not limited to helium, nitrogen, or argon, where a conventional electrical-resistive heater heats the inert gas prior to injection into a plurality of nozzles 7. The coating 3 properties modified by heating the substrate 2 and subsequently the incremental buildup of coating 3 up to annealing temperatures during impact consolidation process include enhanced deposition efficiency, improved densification, dislocation annealing, and improved adhesion and cohesion through in-situ diffusion bonding.

An alternative technique for modifying the chemical properties of the coating 3 during the impact consolidation process would use reactive admixture gases including but not limited to diatomic and mono-atomic species of hydrogen, chlorine, fluorine, and oxygen introduced with a plurality of nozzles 7 surrounding the nozzle jet 1 as shown in FIG. 2. Such gases can be heated to further enhance surface reactivity to potentially strip oxides and contaminates from the surface of the substrate 2, coating 3, or free-form structure. In addition, ionized and plasma species of gases including but not limited to diatomic and mono-atomic species of hydrogen, chlorine, fluorine, and oxygen introduced with a plurality of nozzles 7 surrounding the nozzle jet 1 can used to enhance surface reactivity to potentially strip oxides and contaminates from the surface of the substrate 2, coating 3, or free-form structure.

Addition of hard phase powder particles entrained in the inert gas or inert gas with chemically reactive admixtures introduced with a plurality of nozzles 7 is use to physically strip oxides and other contaminates from the surface of the substrate, coating, or free-form structure by sandblasting or grit blasting the surfaces simultaneous to and in close proximity to the impact consolidation process.

### EXAMPLE 2

The embodiment described by FIG. 2 was tested using a single nozzle 7 to preheat and heat a substrate 2 adjacent to and synchronously with the raster translation of the impact consolidation nozzle 5. Helium gas heated to temperatures of 1000° F. with a 2.5-kW resistive heater was injected into a single gas nozzle 7 and permitted preheating of the substrate 2 to temperatures up to 500° F. while simultaneously depositing a coating 3 onto substrate 2. For this test, the single nozzle 7 was located within a radial distance of 2.54-cm of the impact consolidation nozzle 5 and aligned to raster coincidentally with the impact consolidation nozzle 5 deposition stripe.

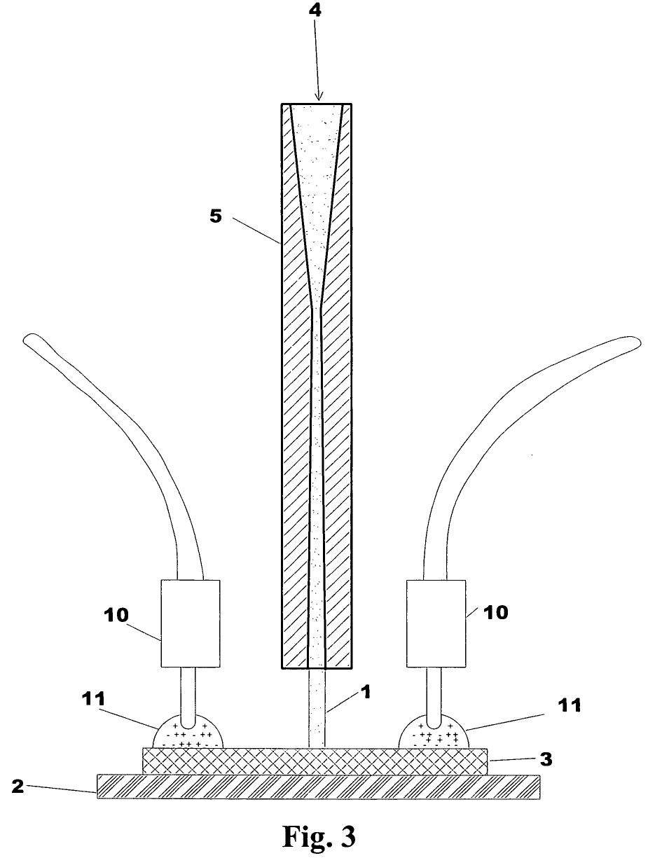

FIG. 3 shows a third embodiment of the invention method for modifying the properties of a substrate, coating, or free-form structure during the impact consolidation process of depositing powders as described in U.S. Pat. No. 6,074,135 issued to Tapphorn and Gabel, U.S. Pat. No. 5,795,626 issued to Gabel and Tapphorn, U.S. Pat. No. B1 5,302,414 issued to Alkhimov, et al., U.S. Patent Application 20020168466, and PCT Patent Application WO 02/085532 A1. Referring now to FIG. 3, a nozzle jet 1 directed toward substrate 2 is shown depositing a coating 3 onto substrate 2 using the impact consolidation process, where the powder entrained in the process gas 4 is injected into the nozzle 5 by means described in U.S. Pat. No. 6,715,640 issued to Tapphorn and Gabel, U.S. Pat. No. 6,074,135 issued to Tapphorn and Gabel, U.S. Pat. No. 5,795,626 issued to Gabel and Tapphorn, U.S. Patent Application 20020168466, PCT Patent Application WO 02/085532 A1 or by other conventional means. A plurality of electrodes 10 impinging arcs or plasma jets 11 onto substrate 2 and subsequently onto the coating 3 or free-form structure in close proximity to the nozzle jet 1 provide the means for heating the substrate 2 and coating 3. The technique can be implemented using tungsten inert gas (TIG) electrodes with a radio frequency arc-starter such as those conventionally used with TIG welders. Other conventional means of using transfer plasma to impinge a plasma jet 11 upon the substrate 2 and subsequently onto the coating 3 or free-from structure are likewise included. The current supplied to the electrodes 10 is controlled to achieve a desired temperature in the substrate and subsequently in the coating or free-form structure. The coating 3 properties modified by heating the substrate 2 and subsequently the incremental buildup of coating 3 up to annealing temperatures during the impact consolidation process include enhanced deposition efficiency, improved densification, dislocation annealing, and improved adhesion and cohesion through in-situ diffusion bonding. Injection of other reactive gases into the TIG electrode supply provide the means of chemically modifying the properties of the substrate 2 and subsequently the coating 3 during the impact consolidation process. Reactive gases including but not limited to diatomic and mono-atomic species of hydrogen, chlorine, fluorine, and oxygen can also be introduced as an admixture into the inert gas supply for the TIG electrode 10. These chemical reactants are used to strip oxides or other contaminates from the surface of the substrate 2 or coating 3 or to enhance the physical properties of the substrate 2 or coating 3 by homogenously dispersing a strengthening agent such as a nitride or oxide within the coating 3 or free-form structure.

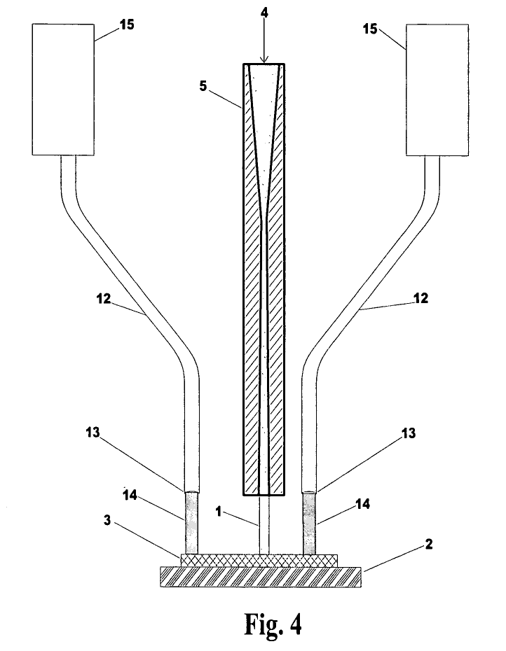

FIG. 4 shows a fourth embodiment of the invention method for modifying the properties of a substrate, coating, or free-form structure during the impact consolidation process of depositing powders as described in U.S. Pat. No. 6,074,135 issued to Tapphorn and Gabel, U.S. Pat. No. 5,795,626 issued to Gabel and Tapphorn, U.S. Pat. No. B1 5,302,414 issued to Alkhimov, et al., U.S. Patent Application 20020168466, and PCT Patent Application WO 02/085532 A1. Referring now to FIG. 4, a nozzle jet 1 directed toward substrate 2 is shown depositing a coating 3 onto substrate 2 using the impact consolidation process, where the powder entrained in the process gas 4 is injected into the nozzle 5 by means described in U.S. Pat. No. 6,715,640 issued to Tapphorn and Gabel, U.S. Pat. No. 6,074,135 issued to Tapphorn and Gabel, U.S. Pat. No. 5,795,626 issued to Gabel and Tapphorn, U.S. Patent Application 20020168466, PCT Patent Application WO 02/085532 A1 or by other conventional means. A plurality of fiber-optic cables 12 with optical lens 13 direct LASER beams 14 from LASER 15 onto substrate 2 and subsequently on to the coating 3 or free-form structure. These LASER beams provide the means for heating the substrate 2 and coating 3 in close proximity to the nozzle jet 1. The coating 3 properties modified by heating the substrate 2 and subsequently the incremental buildup of coating 3 up to annealing temperatures during impact consolidation include enhanced deposition efficiency, improved densification, dislocation annealing, and improved adhesion and cohesion through in-situ diffusion bonding. Chemical treatments of the substrate 2 and subsequently the coating 3 or free-form structure are realized if the gaseous or liquid environment surrounding the impact consolidation nozzle jet 1 interacts with the LASER beam 14 or heated materials to induce a chemical reaction at the surface of the substrate 2, coating 3, or free-form structure.

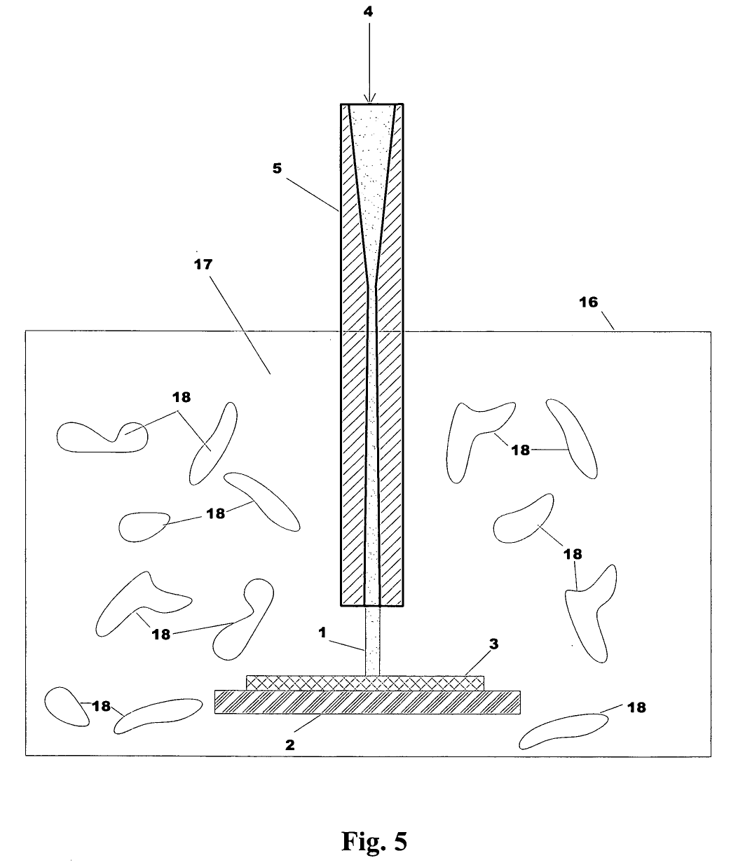

FIG. 5 shows a fifth embodiment of the invention method for modifying the properties of a substrate, coating, or free-form structure during the impact consolidation process of depositing powders as described in U.S. Pat. No. 6,074,135 issued to Tapphorn and Gabel, U.S. Pat. No. 5,795,626 issued to Gabel and Tapphorn, U.S. Pat. No. B1 5,302,414 issued to Alkhimov, et al., U.S. Patent Application 20020168466, and PCT Patent Application WO 02/085532 A1. Referring now to FIG. 5, a nozzle jet 1 directed toward substrate 2 is shown depositing a coating 3 onto substrate 2 using the impact consolidation process, where the powder entrained in the process gas 4 is injected into the nozzle 5 by means described in U.S. Pat. No. 6,715,640 issued to Tapphorn and Gabel, U.S. Pat. No. 6,074,135 issued to Tapphorn and Gabel, U.S. Pat. No. 5,795,626 issued to Gabel and Tapphorn, U.S. Patent Application 20020168466, PCT Patent Application WO 02/085532 A1 or by other conventional means. A vessel 16 surrounding the nozzle jet 1 provides the means of introducing and retaining an inert or chemically reactive gas 17 in close proximity to the nozzle jet 1 to control the chemical reaction properties of the substrate 2 and subsequently the coating 3 or free-form structure. Process gas 18 ejected from the nozzle 5 contributes to sustaining an inert gaseous environment, which modifies the surface properties of substrate 2 and coating 3 or free-form structure by precluding oxidation or chemical reaction. This technique provides a means of depositing very reactive and pyrophoric powders as a coating 3 or free-form structure onto a substrate 2.

Techniques for maintaining a chemically reactive gaseous environment with a stable concentration of the chemical active gas 17 relative to the concentration of the process gas 18 requires further in-situ processing of the gas in the vessel 16. This can be accomplished using conventional gas separation techniques including membrane filters.

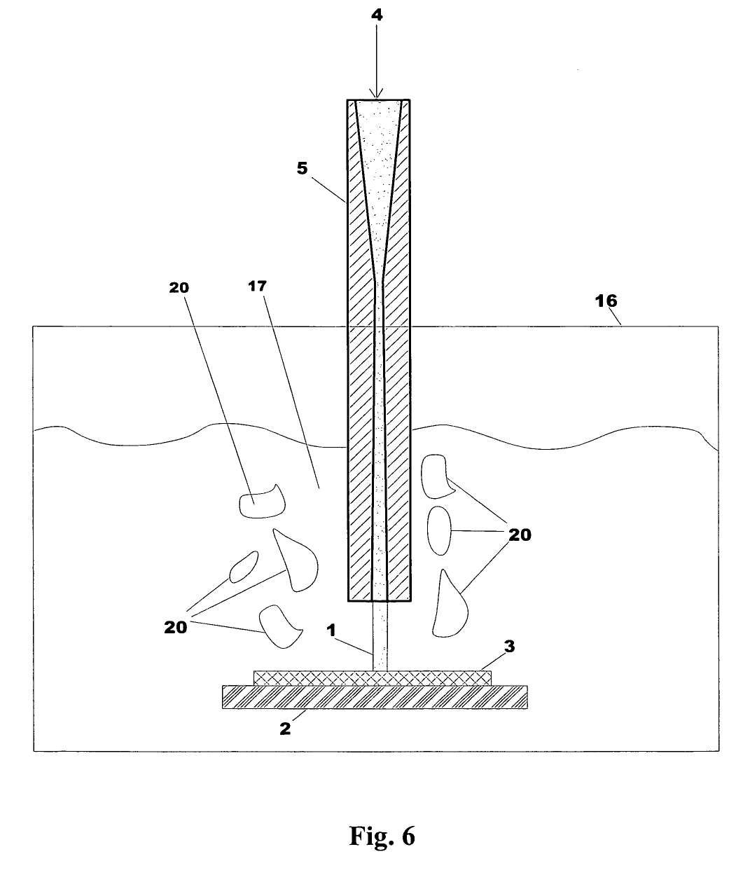

FIG. 6 shows a sixth embodiment of the invention method for modifying the properties of a substrate, coating, or free-form structure during the impact consolidation process of depositing powders as described in U.S. Pat. No. 6,074,135 issued to Tapphorn and Gabel, U.S. Pat. No. 5,795,626 issued to Gabel and Tapphorn, U.S. Pat. No. B1 5,302,414 issued to Alkhimov, et al., U.S. Patent Application 20020168466, and PCT Patent Application WO 02/085532 A1. Referring now to FIG. 6, a nozzle jet 1 directed toward substrate 2 is shown depositing a coating 3 onto substrate 2 using the impact consolidation process, where the powder entrained in the process gas 4 is injected into the nozzle 5 by means described in U.S. Pat. No. 6,715,640 issued to Tapphorn and Gabel, U.S. Pat. No. 6,074,135 issued to Tapphorn and Gabel, U.S. Pat. No. 5,795,626 issued to Gabel and Tapphorn, U.S. Patent Application 20020168466, PCT Patent Application WO 02/085532 A1 or by other conventional means. A vessel 16 surrounding the nozzle jet 1 provides the means of introducing and retaining a liquid shield 19 in close proximity to the impact consolidation nozzle jet 1 to control the chemical reactivity of the substrate 2 and subsequently the coating 3 or free-form structure. Process gas ejected from the nozzle 5 generates bubbles 20 within the liquid shield 19 substance that are subsequently removed from the vessel 16 to preclude a high-pressure buildup during the impact consolidation process. The liquid shield 19 can be selected from a group including but not limited to water, alcohol, ethylene glycol, acetone, silicone liquids, and hydrocarbon liquids. By using inert accelerant gases with the nozzle 5, the nozzle jet 1 displaces the surrounding liquid shield 19 so a not to impede the impact consolidation process, yet provides the means for shielding reactive powders, substrates 2, and coatings 3, or free-form structures from a chemically reactive environment. Thus, this technique enables a submersible process for the impact consolidation of pyrophoric powders and materials without oxidation or combustion.

### EXAMPLE 3

The embodiment described by FIG. 6 was tested by installing a substrate 2 in a vessel that permitted flooding the nozzle jet 1 with 12 inches of water. The test demonstrated that the accelerant gas pressure associated with the impact consolidation nozzle was able to displace the water and permit deposition and build up of powder particles onto the submersed substrate 2 so as to form a coating 3 or permit free-form fabrication. This test was conducted with an aluminum powder to demonstrate the technique, however the invention permits the deposition of reactive powder and pyrophoric powders that would otherwise burn or react in the ambient atmosphere.

Although scope and method of this invention has been described in detail with particular reference to preferred embodiments, other embodiments can achieve the same results. Variations and modifications of the present apparatus and process of the invention will be obvious to those skilled in the art and it is intended to cover in the appended claims all such modifications and equivalence. Then entire disclosures of all references, applications, patents, and publications cited above, and of the corresponding application(s), are hereby incorporated by reference.

1. A method for modifying a coating applied to a substrate or free-form structure, said method comprising:
coating said substrate or free-form structure using an impact consolidation process; and,
heating said substrate, coating, or free-form structure up to annealing temperatures in close proximity to said impact consolidating process to enhance deposition efficiency, improve densification, anneal dislocations, and improve adhesion and cohesion through in-situ diffusion bonding.

2. The method of claim 1, wherein the heating of the substrate, coating, or free-form structure in close proximity to said impact consolidating process is accomplished by means of an electrical resistive heater in thermal contact with said substrate, coating, or free-form structure.

3. The method of claim 1, wherein the heating of the substrate, coating, or free-form structure up to annealing temperatures in close proximity to said impact consolidating process is accomplished by means of a plurality of gaseous jets directed onto substrate, coating, or free-form structure in close proximity to said impact consolidation process providing the means for heating said substrate, coating, or free-form structure.

4. The method of claim 1, wherein the heating of the substrate, coating, or free-form structure up to annealing temperatures in close proximity to said impact consolidation process is accomplished by means a plurality of plasma jets or arcs impinging on the substrate, coating, or free-form structure in close proximity to said impact consolidation process.

5. The method of claim 1, wherein the heating of the substrate, coating, or free-form structure up to annealing temperatures in close proximity to said impact consolidation process is accomplished by means a plurality of LASER beams of electromagnetic radiation impinging on the substrate, coating, or free-form structure in close proximity to said impact consolidation process.

6. A method for modifying a coating applied to a substrate or free-form structure, said method comprising:
coating said substrate or free-form structure using an impact consolidation process; and,
treating said substrate, coating, or free-form structure in close proximity to said impact consolidating process by exposure to a gas or liquid environment.

7. The method of claim 6, wherein the treating of substrate, coating, or free-form structure in close proximity to said impact consolidation process comprises exposing the substrate coating, or free-form structure to a reactive gas.

8. The method of claim 7, wherein the treating of substrate, coating, or free-form structure in close proximity to said impact consolidation process comprises exposing the substrate coating, or free-form structure to a reactive gas selected from the group consisting of diatomic or mono-atomic species of hydrogen, chlorine, fluorine, oxygen, and mixtures thereof.

9. The method of claim 7, wherein the treating of substrate, coating, or free-form structure in close proximity to said impact consolidation process comprises exposing the substrate coating, or free-form structure to ionized and plasma species of a reactive gas selected from the group consisting helium, hydrogen, chlorine, fluorine, oxygen, argon, and mixtures thereof.

10. The method of claim 6, wherein the treating of substrate, coating, or free-form structure in close proximity to said impact consolidation process comprises exposing the substrate coating, or free-form structure to an inert gas.

11. The method of claim 10, wherein the treating of substrate, coating, or free-form structure in close proximity to said impact consolidation process comprises exposing the substrate coating, or free-form structure to an inert gas providing the means for deposition of reactive or pyrophoric powders.

12. The method of claim 10, wherein the treating of substrate, coating, or free-form structure in close proximity to said impact consolidation process comprises exposing the substrate coating, or free-form structure to an inert gas selected from the group consisting of helium, nitrogen, argon, and mixtures thereof.

13. The method of claim 6, wherein the treating of substrate, coating, or free-form structure in close proximity to said impact consolidation process comprises exposing the substrate coating, or free-form structure to a liquid.

14. The method of claim 6, wherein the treating of substrate, coating, or free-form structure in close proximity to said impact consolidation process comprises exposing the substrate coating, or a liquid selected from the group consisting of water, alcohols, ethylene glycol, acetone, silicones, and hydrocarbons, and mixtures thereof.

15. The method of claim 6, wherein the treating of substrate, coating, or free-form structure in close proximity to said impact consolidation process comprises exposing the substrate coating, or free-form structure to an inert liquid providing the means for deposition of reactive or pyrophoric powders.

16. The method of claim 15, wherein the treating of substrate, coating, or free-form structure in close proximity to said impact consolidation process comprises exposing the substrate coating, or free-form structure to an inert liquid selected from the group consisting of water, alcohols, ethylene glycol, acetone, silicones, and mixtures thereof providing the means for deposition of reactive or pyrophoric powders.
